(19) United States
(12) Patent Application Publication
(10) Pub. No.: US 2008/0086534 A1
(43) Pub. Date: Apr. 10, 2008

(54) System and method that combines gaming and social networking

(76) Inventors: Ulas Bardak, Lefkosa (CY); Betty Yee Man Cheng, Pittsburgh, PA (US); Jahanzeb Ahmed Sherwani, Karachi (PK); Vasco Calais Pedro, Pittsburgh, PA (US)

Correspondence Address: MEYER UNKOVIC & SCOTT LLP, 1300 OLIVER BUILDING, PITTSBURGH, PA, 15222, US

(21) Appl. No.: 11/973,201

(22) Filed: Oct. 5, 2007

Related U.S. Application Data
(60) Provisional application No. 60/849,381, filed on Oct. 5, 2006.

(51) Int. Cl. G06F 15/16

(52) U.S. Cl. 709/206

(57) ABSTRACT

A system and method for obtaining personal data about registered users using gaming principles is described. A data storage component receives and stores one or more items of personal data for each registered user. Multiple messages authored by multiple registered users are generated and displayed to a user interface for each registered user. The user interface provides a means for one registered user to select and categorize a message authored by another registered user. Based upon the nature of this categorized response, the responding user or seeker either gains or loses an item of personal data about author-user. Competition among users at different levels is introduced by applying a sorting process that limits the messages displayed to a particular user. In addition, resource management tools can be applied to limit author-user messages and seeker-user responses. Further, user actions and messages are scored and rankings are provided to all users. A communications link, allowing direct communication among users, can be provided when one user is awarded a sufficient amount of personal information about another user.

### PRIORITY

This application claims the benefit of U.S. Provisional Application Ser. No. 60/849,381, filed on Oct. 5, 2006.

### FIELD OF THE INVENTION

The present invention relates generally to social networking and gaming, and more specifically it relates to a system and method for dynamic, real-time broadcast and display of short messages from numerous users over a network, and using these messages, along with principles of gaming, for forming social networks.

### BACKGROUND OF THE INVENTION

With the spread of broadband internet in the past several years, there has been a flourishing of social networking devices such as instant messaging programs, chat rooms, message boards and social networking websites, including those focused on dating, friendship, professional relationships and commercial benefit. Instant messaging programs and chat rooms encourage conversations between people who already know each other, either in real life or via other medium, while message boards encourage conversations to remain in the specified domain of the message board. Although social networking websites promote the meeting of new people via mutual connections, common interests and/or physical appearance, the onus falls on the users to seek out new connections. Similarly, online dating sites in most cases require the user to provide constraints for a search over all registered users, and it is up to the user to manually sift through the resulting profiles to find potentially suitable matches. For both social networking and online dating, it is difficult for two non-extroverted users without any prior acquaintance to initiate communication, since there is no shared history on which to build. This contrasts with specific kinds of social interaction in the real world, such as between co-workers in the same workplace, and students in the same class. Thus, at one level, what is needed is a mechanism to create a shared experience between two anonymous users, on which a deeper relationship can be built potentially more easily and it is up to the user to sift through the resulting profiles to find potentially suitable matches.

At the same time, while online gaming is suitable for entertaining users over the Internet, there are no online games that incorporate a substantial element of social networking. Online virtual worlds have recently involved a larger amount of social interaction, but even then it is either more as a side activity to the game itself and often encourages users to interact as different personas instead of as themselves.

What is needed is an interactive interface in an online computer system that combines social networking and online gaming and, more specifically an interface having an environment that entertains the user while they are involved in social networking or alternatively, encourages social exploration while they are involved in online gaming. The gaming elements of the interface would give incentives for users to interact with the system. In particular, the system would provide for differentiated knowledge about users such that a user would be rewarded, or awarded with, additional items of personal knowledge about other users pursuant to the gaming aspects of the system and thereby develop relationships upon such knowledge. In addition, the system and method could provide for penalties whereby knowledge about users is subtracted or deleted.

### SUMMARY OF THE INVENTION

The present invention provides a system and method for users to interface in an online computer system that combines elements of social networking and online gaming and can be utilized for meeting new people through the process of a people-oriented social game. This system and method focuses on the use of gaming principles to encourage users of the system and method of the present invention to learn more about other users by providing a system of rewards and penalties associated with responses to messages posted by such other users. In particular, the responses can either trigger rewards that add to, or penalties that subtract from, the personal data associated with other users.

A further object of the present invention is to provide an infrastructure whereby users interested primarily in game play are able to do so through a game targeted towards building new relationships.

A further object of the present invention is to provide an infrastructure whereby users interested primarily in finding new relationships are able to do so through an entertaining, game play-based experience.

A further object of the present invention is to use game design concepts, including rankings, competition, rewards/penalties and resource management tools such as scarcity of time or credits to encourage social interaction.

A further object of the present invention is to encourage thoughtful authored messages by using a sorting system, based upon the application of selection criteria, to determine which messages to post.

A further object of the present invention is to include resource management components into the system and method of posting and responding to messages from individual users so that interaction among multiple users is encouraged. Such resource management components can include time limits such that, for example, a user can only post new messages within certain time intervals and can also include scarcity concepts such as credits that are obtained and used through the process of providing positive or negative responses on other posted messages.

A further object of the present invention is providing a ranking of messages authored and users based upon their authored messages and responses.

This system and method of the present invention is accordingly comprised of a number of components and features. The main component, Thought Stream™, is a dynamic and real-time display of personalized messages from multiple users. Each message posted to the Thought Stream™ preferably has an associated “energy level” determined by a sorting or ranking system that reflects the importance, popularity among the community as a whole and recentness of an authored message or “thought” Whether or not a personalized message is posted between an author and other individual users depends on the system's consideration of sorting criteria, including the energy level of the message, the strength of the connection between the user and author of the message, and the user's responses on messages in the past, as well as custom filters (based on age, gender, language, etc.) set by the user or seeker. These concepts of sorting and message competition are introduced from game design into the system and method of the present invention to motivate users to write more meaningful thoughts to attract responses from other users. By way of further example, controversial or thought-provoking messages can be encouraged by sorting/scoring criteria where any response contributes positively to the message's rank regardless of the nature of the response, e.g., the number of both positive (“like”) and negative (“dislike”) responses to a message and added. Similarly, positive messages can be encouraged by a sorting/scoring criteria based on subtracting the number of negative responses from the number of positive responses.

To make connections with other people on this system, a user or seeker submits responses on posted messages. The responses may be discrete, either positive or negative, or on a continuous range. With each positive response, the user or seeker is rewarded with a portion or item of personal data about the author of the message. With each negative response, the user is penalized by losing a portion/item of personal data previously awarded to the user about the author of the message. Personal data about the author used in these rewards and penalties can be explicit information in the user profile of the author (e.g., the author's name, e-mail, image, gender, friends, current job, education level, faith, sports, activities, interests and hobbies, language fluencies, etc.), implicit information collected from the author's interaction with the system (e.g., other posted messages on which the author has given positive or negative responses or provided some other response), or possibly even information about the author from other, system-external sources.

The system and method of the present invention employs resource management components to encourage broader interaction among users. For example, a user can be limited to posting a specified number of messages to the Thought Stream™ per a given time interval. Such limitation discourages the user from having private conversations with users already known and from posting mindless chatter such as “hello” and “anyone out there?”.

By way of further example, to prevent users from submitting positive responses on all messages, the system can include resource management components, such as a credit system, where each positive response costs the user 1 credit, and each negative response gives the user 1 credit. This management tool implements an element of scarcity into the system and method of the present invention, which is a common practice in game design but entirely absent in social networking systems.

In addition, competition among users is encouraged by a ranking system that identifies author-users and seeker-users based upon selected criteria such as, for an author, total number of messages and/or total number of messages “liked”. For a user-seeker, ranking can be based on total responses and/or portions of personal data learned about other users. The system also contains an interface whereby users may view their ranking with respect to all other users. The use of viewable rankings provides another incentive for users to perform well in the game, and hence encourages the formation of social networks.

### BRIEF DESCRIPTION OF THE FIGURES

FIG. 1 is a flowchart of the system architecture of one particular implementation of the invention.

FIG. 2 is a flowchart of the processes that take place when a user applies a label to a thought in one embodiment of the present invention.

FIG. 3 is a flowchart that describes the process of logging onto the system in one embodiment of the present invention.

FIG. 4 is a flowchart that describes the process of authoring a thought in one embodiment of the present invention.

FIG. 5 is a screen shot of the Thought Stream™ in one embodiment of the present invention.

FIG. 6 is a portion of a screen shot showing an example of user-enabled filters that can be applied to authored messages in one embodiment of the present invention.

FIG. 7 is a portion of a screen shot showing an example of user response options to an authored message in one embodiment of the present invention.

FIG. 8 is a portion of a screen shot showing the resource management tools in one embodiment of the present invention.

FIG. 9 is a portion of a screen short showing all the personal data the user has collected about another user in one embodiment of the present invention.

FIG. 10 is a portion of a screen shot in one embodiment of the present invention, with the left portion showing a list of users for whom the user has collected personal data, with a preview of the personal data displayed in a pop-up when the mouse hovers over the user's image; and the right portion showing a temporary pop-up of the new section of image awarded to the user.

FIG. 11 is a portion of a screen shot showing a user's personal profile area in one embodiment of the present invention.

FIG. 12 is a portion of a screen short showing the collected personal data of another user or Mindkin™ area in one embodiment of the present invention.

### DETAILED DESCRIPTION OF THE INVENTION

Embodiments of the present invention are described herein in the context of a system and method for social networking in an online computer system based upon application of gaming principles to such networking. Those of ordinary skill in the art will understand that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The drawings, in which similar reference characters denote similar elements throughout the several views, illustrate one of many possible implementations of our invention.

In the interest of clarity, not all of the routine features of the implementations described herein are shown and described. It will be understood by those skilled in the art that in the development of any such implementations, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems; computing platforms; user interfaces/displays, including personal or laptop computers, PDAs and other handheld devices, such as cellular telephones; and/or general purpose machines. In addition, those of ordinary skill in the art will recognize that devices of a less general purpose nature, such as hardwired devices, field programmable gate arrays (FOGs), application specific integrated circuits (ASICs), or the like, may also be used without departing from the scope and spirit of the inventive concepts disclosed herein.

As used herein, the terms “seeker”, “seeker-user”, “responding user”, “user-responder” and variations thereof can be used interchangeably. The terms “label”, “response”, “category” and variations thereof can be used interchangeably. The terms “section”, “segment”, “portion” or “item”, and variations thereof can be used interchangeably. The terms “awards”, “rewards”, “credits” and variations thereof can be used interchangeably. The terms “rank”, “sort”, “score” and variations thereof can be used interchangeably.

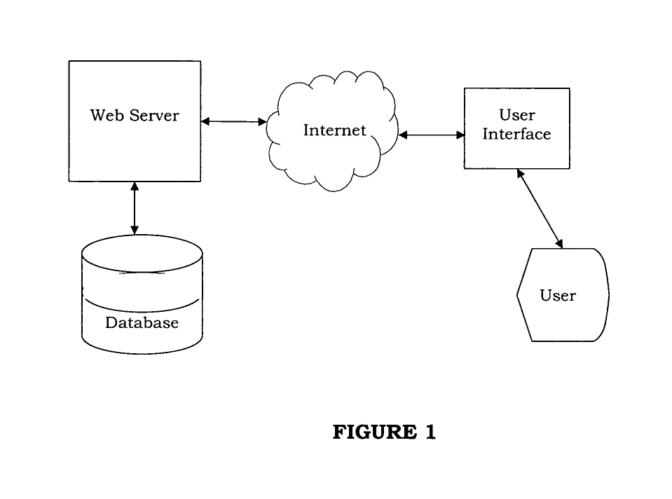

The general components of the present invention are now described, followed by a detailed description of the invention with reference to FIGS. 1 through 12.

User Profile. When a user registers to use the system and method of the present invention, the user creates a parsable user profile. By parsable, it is meant that individual portions/items in that profile may be divided for awarding to a registered user who has incrementally earned access to same. This profile includes personal information entered by the user including, without limitation, a user's actual name, system user name, gender, contact information (such as an email or other system address) and image. Other user information can also be provided. The information in the user profile is part of what a user can earn or be awarded as a seeker of other user information. In one embodiment of the invention, for example, a user's image can be split into a number of portions or sections, e.g., nine, and a seeker-user, through use of the invention's message and gaming system, seeks to obtain all nine portions/segments of the image. The same “seeking” process can apply to other user profile information.

Dynamic, Real-time Display of User Messages. The present invention provides a system and method for the dynamic and real-time display of personalized messages from multiple users known as Thought Stream™. Preferably, the system and method of the present invention employs a selection system in connection with the presentation of different authored message to a given user. More specifically, a small subset of authored messages is displayed to each individual user (which messages would differ from user to user), with the selection process for each user being based upon multiple factors including, but not limited to play it or not) are based on all or some of the following:
In one embodiment, the “energy level” of a message can be a function of: the time elapsed since an authored message was written; the time elapsed since any responses were provided to the message and/or the number of total and/or positive responses to the message.
Separate from the “energy level”, the number of users that have responded to an authored message in any manner and/or in a certain manner, e.g., liked or disliked.
How close or proximate the author of the message is to the user to whom the authored message is being considered for display, with proximity being defined based upon a combination of factors including but not limited to: (i) distance in the social network, that is the identification of common friends as listed in the user profiles of the author-user and seeker-user; (ii) distance in geographic location between the author-user and seeker-user; and/or (iii) how many explicit and/or implicit portions/items of data the seeker-user has discovered about the message author (which is otherwise referred to herein as the strength of the link between to users.
The commonality between the content of the authored message and the content of past messages to which the user responded in a similar or any manner.
User preference for how many messages to be displayed.
User ability to respond to messages displayed in the past.

Based on combinations of these factors, only the messages with the highest weighted sum or highest cumulative values of these features would be shown to a particular user subject to user customized, message filtering.

The actual display of authored messages preferably is designed to be aesthetically pleasing through the use of color, motion and effects such as fade-in and fade-out, such that users have an incentive to interact with the display, or watch it passively.

User Responses to Authored Messages. To make connections with other author/users, each individual user submits responses to authored messages displayed to that user. Such responses are usually binary in nature. The responses preferably vary based upon criteria and intensity. Two examples of criteria are agreeability and likeability; others may be “agree” or “disagree”, or “funny” vs. “serious”. These responses can be applied separately. Specifically, criteria options can be distinct from one another such that a user may submit different responses on a single authored message with respect to different criteria. For example, a user may “agree” with a message but “dislike” it. In addition, the intensity of responses can be indicated on a continuum, i.e. a continuous range or spectral scale, between a discrete set of values. For example, a user can numerically rank his “dislike” of an authored message or otherwise assign rating values of, for example, “strongly”, “moderately” or “slightly”.

Resource Management. The system and method of the present invention makes use of the scarcity of resources principle of gaming. More specifically, users are provided with only a limited amount of resources, such as time, credits or currency, to use in taking actions in the system and, in a preferred embodiment, in creating more resources. This concept of scarcity is employed in the system and method of the present invention to encourage the users of the system to act with care. For example, resource management tools may be employed as currency that can be exchanged in order to submit a message or to respond to messages submitted by other users.

The replenishment of resources can occur through actions of the user, through the actions of other users by way of their responses to the actions undertaken by the original user, or even simply through the passing of a certain interval of time.

Use of Rewards and Penalties to Motivate the Development of Social Networks. The system and method of the present invention employs the principles of rewards and penalties from gaming principles to motivate the development of social networks. In traditional social networking systems, users need to take the initiative in creating connections with others by reading through hundreds or thousands of user profiles. Even with the assistance of filters and search engines based on common interests and mutual connections, such a task often leads to many users losing interest. Moreover, once the user has read the other user's profile, the connection process is complete. There is no mechanism to help or encourage the user to learn more about the other user except the ability to send him/her a private message which can be intimidating for many users at an early stage of networking, particularly for shy users.

In the system and method of the present invention, the process of developing a social network connection is significantly different in comparison to existing social networking systems. More specifically, a user of the present invention is not actively reviewing and searching through the profiles of other users. Each user is presented with select authored messages posted by other users, much like a message board or RSS feed. In one preferred embodiment, authored messages are anonymous when displayed, unless a user has acquired all specified personal data about that author. Depending upon a user's response on authored messages, the responding user is given an immediate reward or penalty. Specifically, a positive response on an authored message rewards the user with a portion of explicit or implicit data or information about the author of the message, while a negative response penalizes the user by taking away a portion or item of personal data/information the responding user has collected about the author. Thus, positive responses on a message results in the system strengthening the connection between the two users, while a negative response results in a weakening of the connection.

This reward/penalty method is preferably coupled with a resource management tool, such as a credit system, to ensure that a responding user does not give positive response on all messages. In particular, a responding user must apply credits in order to provide a positive response and can obtain new credits by other actions including providing negative responses, obtaining positive responses on the responding user's own authored messages, allowing time to pass from the last message sent. This reward/penalty system encourages the responding user to develop strong connections with other authoring users that the responding user is truly interested in interacting with, as opposed to weak connections with many random users. In addition, since the process of labeling posted messages is a relatively passive process, even the shyest users will develop their social networks unconsciously. Furthermore, the rewards and penalties promote an interesting and addictive gaming environment that encourages users to continue seeking out new connections and strengthening existing ones.

Rankings. The system and method of the present invention optionally can analyze the usage of resources by a user and produce rankings based on the actions taken with those resources. The rankings may be based on, but not limited to, (i) top authors, (ii) top seekers, and (iii) top thoughts. For author-users, rankings can be based on the total number of messages submitted by each author-user and the volume and nature of responses received on such message from other users. For seeker-users, rankings can be determined by volume and nature of responses or a combination thereof. Top thoughts/messages can be ranked based upon the volume and nature of responses received for each message. These rankings can be at the daily, weekly or database level. Rankings are displayed to all the users both for informational purposes and to encourage competition amongst users, which is another important concept in gaming.

FIG. 1 illustrates the general architecture of a system and method that operates in accordance with one embodiment of the present invention.

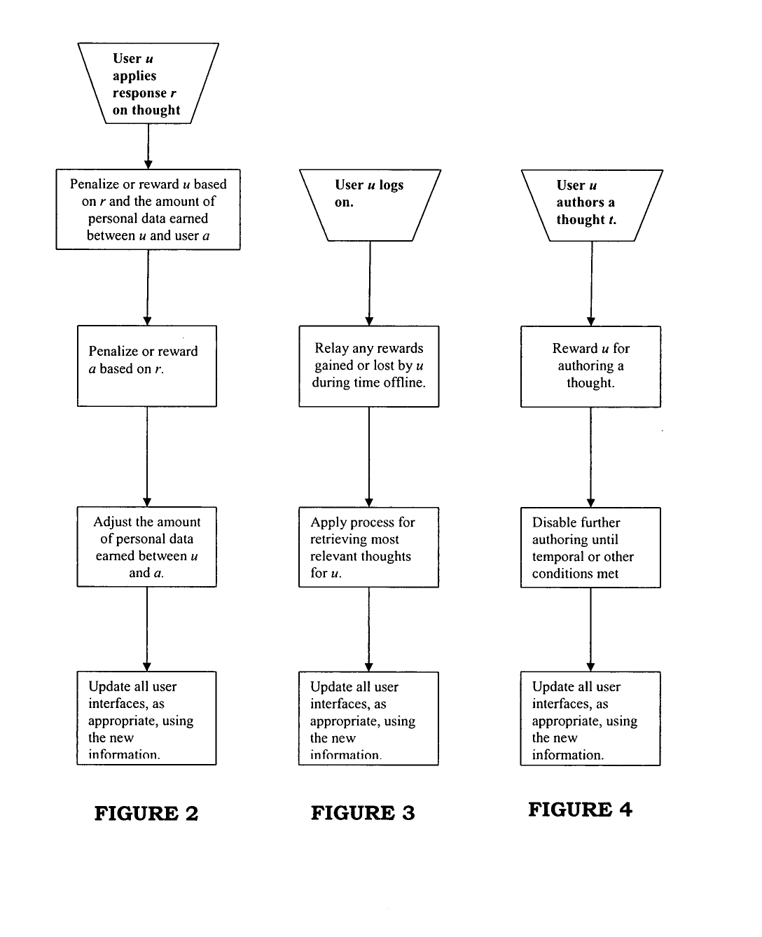

FIG. 2 describes the processes that take place when a user applies a response or label to a message or thought in one embodiment of the invention. Depending on the response or label used, and the strength of the link between this user and the author of the message, i.e., the volume of personal data earned or awarded between the two, the user is either rewarded or penalized by earning or losing personal data about the author. Optionally, the author of the message can be rewarded or penalized in similar manner based on the categorized response used and the strength of the link between the user and the author. The strength of the link between the user and author is thereafter adjusted. Finally, the user interface for all users is updated to reflect these changes, as necessary. Specifically, the user can receive a pop-up noting that personal information has been earned or lost, and the author can receive a pop-up that a response of a certain nature has been received. In addition, the user's Mindkins™ display will update and ranking displayed across all user interfaces may be adjusted.

FIG. 3 describes the process of logging onto the system in one embodiment of the invention. When a user logs on, the user is shown any rewards gained or lost during the time the user was offline. Through application of the message sorting process described previously, the system builds a list of thoughts that are most relevant for the user, and displays those thoughts to that user. Again, user interfaces for all users are updated to reflect these changes, as appropriate.

FIG. 4 describes the process of authoring a thought in one embodiment of the invention. When a user authors a thought, the user-author is rewarded. However, the system disallows the author-user from authoring further thoughts until a specific time period elapses, or other conditions are met, such as when another user responds to or labels the user-author's message or thought. Finally, the user interface for all users is updated to reflect these changes as necessary.

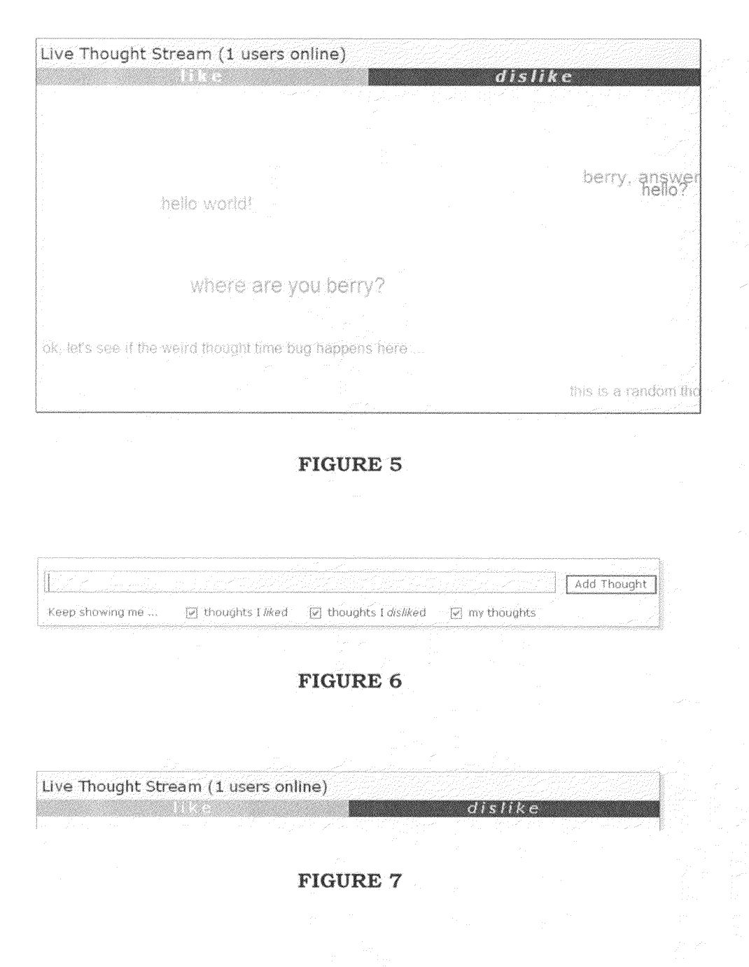

FIG. 5 is a visual representation of a screen shot of the Thought Stream™ display in a preferred embodiment of the present invention. User messages (also known as “thoughts”) preferably move in from right to left over an area of the screen, with different colors, sizes, fonts, and scroll speeds within the system ranges set by the user. Where messages are displayed in a different language where reading occurs in a different pattern, e.g., from right to left, the direction of the message across the screen can change so that they enter from the left and move to the right. Similarly, messages can move from bottom to top for languages that are read vertically, e.g. Chinese or Japanese. Messages enlarge and slow down when the mouse hovers over them, and return to their original size and speed when the mouse leaves. This display format provides an aesthetically-pleasing user experience for reading messages that might otherwise be moving too fast, or be written in a font that is too small to read comfortably. Messages also can be coded to represent various features of each message authors, such as, for example, different colors representing gender. Users also can set their speed for messages. This speed control can apply separately to different types of messages based upon differentiation between authors (e.g., gender) and can also be applied to the average speed of all messages.

Also in connection with the Thought Stream™ display in a preferred embodiment of the invention, FIG. 6 shows an example of user-enabled filters that are utilized by the system in determining which authored messages to present to an individual user. As shown in FIG. 6, these filters can include reference to thoughts liked or disliked. Filters can also focus on other message attributes such, for example, as subject and reaction of other users to the message (generally liked or disliked). Other filter categories can include geographic location, gender, keywords, age, education/major/field of study, political affiliation or any other personal information included in a user profile. In an alternative embodiment, users may, through filters or other controls, manage or create message channels based upon filter categories. In addition, users may have access to multiple channels.

As seen in FIG. 7, a responding user has the ability to respond to an authored message using criteria set by the system. According to FIG. 7, one set of criteria can include labels of “like” or “dislike”. As discussed above, such responses on an authored message can allow the responding user to either acquire or lose a piece of information about the author of the message. In one embodiment of the present invention, the responding user can only submit one response, per criteria set, for each message. If there are multiple criteria sets, then the user can submit multiple responses per message. That is, if a responding user has selected the “like” criteria for a message then that use cannot later “dislike” the message, or vice versa. However, the user may separately select from a criteria set of, for example, “agree” or “disagree”. Other response criteria also may be added in addition to “like”/“dislike”, such as, for example, a numerical or strength rating of the degree of liking or disliking a message.

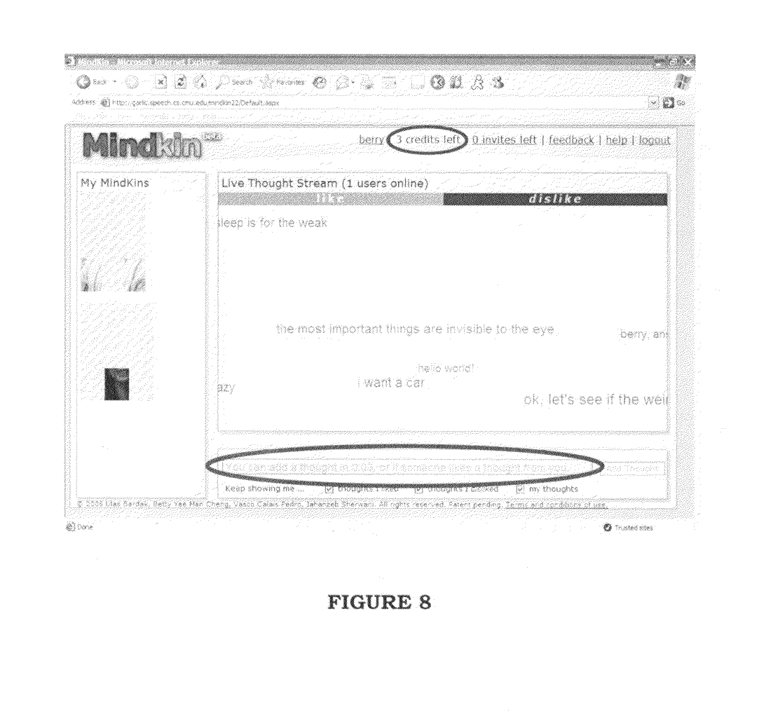

FIG. 8 is a screenshot of the system and method of the present invention in use on an online computer system and is representative of the present invention's use of scarcity as a gaming tool. Specifically, in one embodiment of the present invention, scarcity tools can limit the number of thoughts a responding user can label, and such tools can also determine whether or not the user can post a thought to the Thought Stream™.

As shown in FIG. 8, a credit feature can be employed to limit and control labeling of messages by a responding user. In particular, upon registering and logging into the system for the first time, each user is given a discrete number of credits (for example, three credits, as shown in FIG. 8). These credits are spent one at a time as a responding user labels messages or thoughts. When these credits run out, a user can only gain credits in differing manners (which can be used alone or in combination in embodiments of the present invention). Such means of regaining credits can include: (i) resetting the number of credits at the start of a set time period, such as one hour; (ii) receiving a credit when a responding user labels a message as being disliked or in some other similar negative manner; and/or (iii) receiving positive responses from another user on a posted message. A similar resource management tool can apply to the process of posting a message; that is, a user-author may have time limits on the ability to post a message and, in an alternative embodiment, may be required to expend credits when posting a message. These resource management tools are separate from one another such a time limitation on authoring message would not impact a user's ability to reply to other messages.

In one embodiment of this invention that provides like/dislike responses or labels, most responding users prefer to “dislike” certain thoughts for gaining credits instead of waiting until the start of the next hour. As a result, most users will have a 1:1 ratio of “liked” to “disliked” thoughts, rather than a greater ratio (i.e. mostly “liked” thoughts and very few “disliked” thoughts).

As also shown in FIG. 8, when the user submits a message or thought, one embodiment of the present invention disables that user's ability to send a sending a further thought or message for a select period of time (for example, 3 minutes, as shown in FIG. 8). At the same time, though, the author-use can still submit responses to other messages (subject to any resource management limitations on that process). This time limitation optionally can be withdrawn if another user marks one of the original user's thoughts as one he/she “likes”, at which point the ability to send a new thought or message would be re-enabled automatically by the system.

FIGS. 5, 10 and 12 are screen shots from one embodiment of the present inventions that show one means of depicting the pieces of information learned about other users. This is the information gained as a reward, or that can be lost as a penalty, based upon the nature of a responding user's labeling of authored messages. The information can be either explicit information entered by a message author or implicit information collected from the message author's activities on the system. In one method of the present invention, explicit information would include information in the user-author's profile, such as, for example, gender, sections of an image and an e-mail address, as well as messages posted by the author. In one embodiment, a user can be rewarded with the email address for another user after obtaining all of the sections of the image for that other user. Implicit information can include, by way of example and not limitation: (i) messages on which the author, as a responding user, has given positive or negative responses, (ii) mutual contacts between the message author and the responding user, (iii) the number of users who have made connections with the message author, (iv) the number of thoughts published by the message author, (v) the popularity of the message author's thoughts and rankings by associated statistics, and (vi) the number of other users who have discovered portions or sections of the author's image.

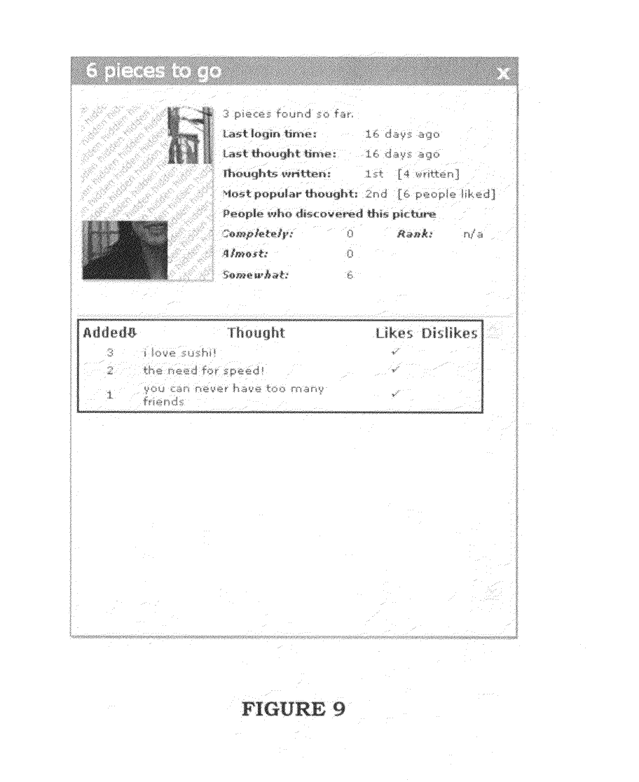

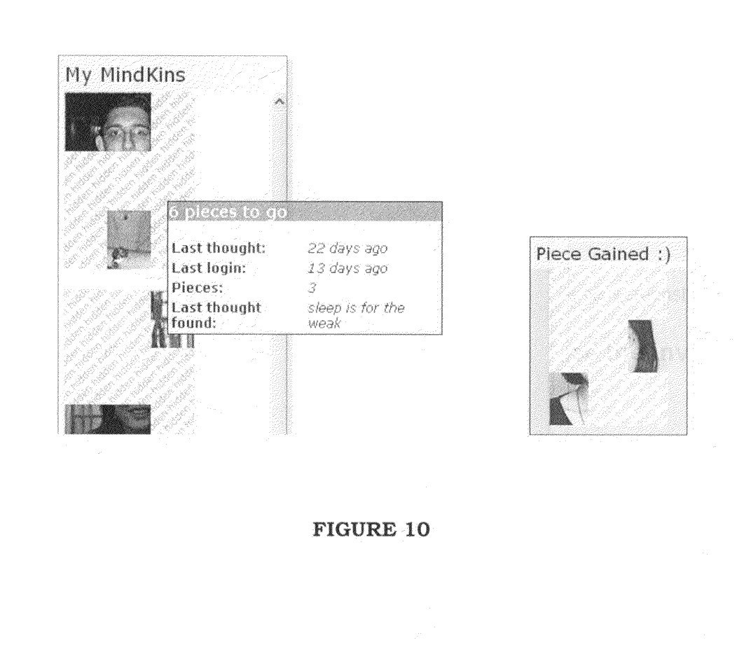

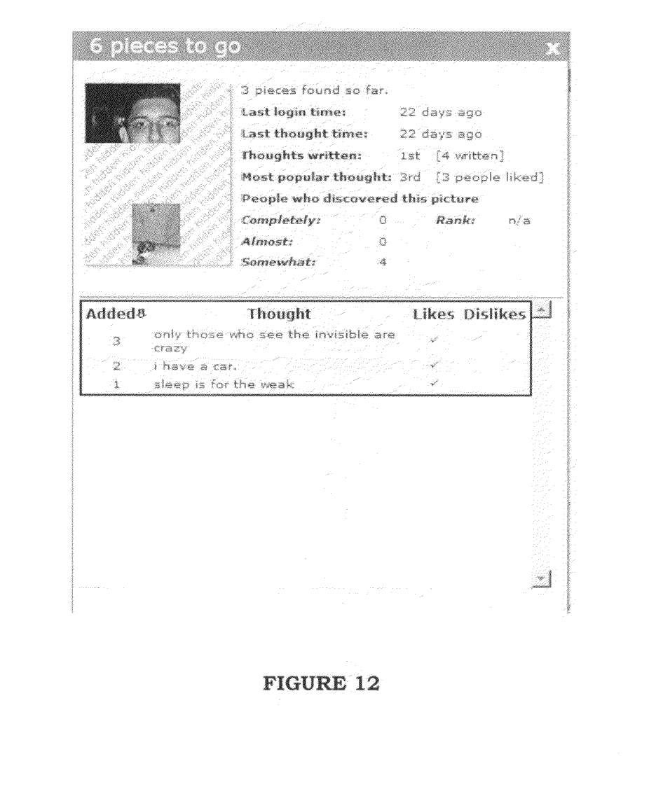

FIGS. 9 and 12, in particular, show windows capturing all the information a user has collected about other users, otherwise known as Mindkins™. The windows show, in both a narrative and pictorial format, the items of information that remain to be learned about another user, including sections of an image for that user. FIG. 10 (at the left) shows the list of users (or Mindkins™) for whom the user has collected information, with one embodiment of the present invention allowing for a preview of the information through display in a pop-up when the mouse hovers over the user's image. When a new piece of information is learned about another user, one embodiment of the present invention awards the responding use with a section of the image corresponding to the author/user. In addition, the new information is displayed in a temporary pop-up as shown in FIG. 6 that fades away after several seconds. Optionally, a list management tool can be provided that groups Mindkins™ into categories, such as the amount of information learned about a Mindkin™, e.g., no information, small amount of information, large amount of information and all information. This list management helps prevent the overall list of Mindkins™ from getting crowded.

In an alternative embodiment of the present invention, a ranking mechanism can be implemented that allows all users to view a Hall of Fame, containing information about top-ranked users and thoughts. By way of example, but not limitation, such Hall of Fame rankings can include: (i) the users that have submitted the largest number of responses of any nature; (ii) the users that have submitted the largest number of responses of a particular nature, based upon available response criteria, e.g., the user that has submitted the most “liked” messages; (iii) the users that have submitted the largest number of messages or thoughts to the Thought Stream™; (iv) the users that have submitted the largest number of messages or thoughts receiving responses of a particular nature; (v) the users who have collected all sections of another user's image or the largest number of aggregate portions of personal data about other users; and (vi) the messages that have received the largest number of responses of a particular nature. Optionally, the present invention permits a user to directly or quickly access a communications connection, e.g., email, to the highest ranking authors and responding users in the main system window.

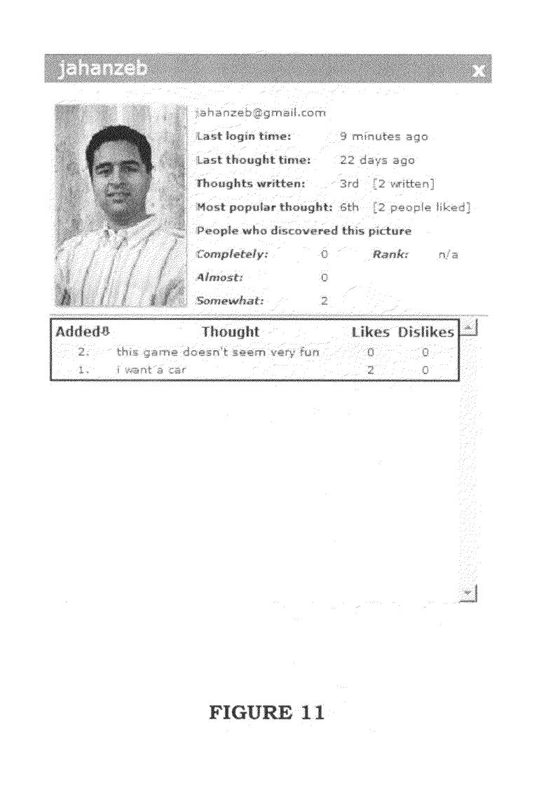

In addition, in an optional preferred embodiment of the invention, each user has a personal user area, as shown in FIG. 11. This personal user area displays personal data and associated rankings, with such data including, but not limited to: (i) the number of thoughts a user has posted to the Thought Stream™, (ii) the user's most popular thought and its rank in comparison to other users (iii) the number of other users who have collected sections of the first user's image, and (iv) the number of times each of the user's thoughts have been labeled as “liked” or “disliked”. In one embodiment of the invention, rankings for an individual user are broken out as to that user's role as author of messages and also as user-responder or seeker as that user selects responses to other user messages or thoughts.

In an alternative embodiment of the system and method of the present invention, communications between users can be improved by an instant chatting message system that allows online and offline messaging whereby a user can send and receive messages with the user's Mindkins™. Such communications can be further improved with other features, including: (i) a notification feature that allows a user to know when identified authors join or are already using the system and method of the present invention; (ii) the ability to ban or block other users from sending messages or receiving notice that a first user is online; (iii) conferencing among multiple users, including the use of voice and video communication; (iv) mini-profiles and sub-lists for Mindkins™ to improve identification of users where communication is desired; and (v) “ice-breaker” games, ranging from the simple, e.g., true/false questions, to the complex, e.g., pong or board games.

Other optional components or features of the invention include: (i) the generation of seed thoughts to give users new thoughts to respond to when not enough users are online (these seed thoughts can be generated from past authored messages or from an independent list of messages, in which case responding users would be pared with other authors based upon similarity of messages and responses; (ii) the ability of users to post multimedia content, such as images, sounds and movies, in connection with authored messages; (iii) linking the networking system to a mobile device such as a PDA or cell phone; and (iv) adding a plug-in that would allow users to passively or actively plug into established social networking sites such as FACEBOOK® and others.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

What is claimed is:

1. A system of obtaining personal data about registered users of said system using gaming principles, said system comprising:
a. a data storage component onto which one or more items of personal data for each registered user is stored;
b. a message processing component for receiving multiple messages authored by multiple registered users, said message processing component associated with said data storage component; and
c. a user interface for each registered user for displaying said multiple messages received by said message processing component, said user interface including means for a first registered user to select and categorize a message authored by a second registered user;
said message processing component receiving said first registered user's categorized response to the message of said second registered user and, based upon the nature of said categorized response, awarding an item of personal data about said second registered user to said first registered user.

2. The system of claim 1 which further comprises a resource management tool that limits the number of messages said first registered user may select and categorize, said resource management tool selected from the group consisting of: (i) a credit controller that provides credits to said first registered user that are expended or earned based upon said first registered user's categorization of other user messages; (ii) a timing controller that limits when said first registered user can select and categorize other user messages, and (iii) combinations of the above.

3. The system of claim 1, which further comprises a resource management tool that limits the number messages any registered user can author, said resource management tool selected from the group consisting of: (i) a credit controller that provides credits to each registered user that are expended as messages are authored and are earned based upon the categorization of said author-user's messages by other registered users, (ii) a timer controller for limiting how often any user can author a message, and (iii) combinations of the above.

4. The system of claim 1, which further comprises a resource management tool that adjusts the duration a message is available for selection and categorization based upon criteria selected from the group consisting of: (i) the time elapsed since the message was first submitted by the message author; (ii) the time elapsed since the message was last selected and categorized by any user; (iii) the number of times the message is selected or categorized by any user; (iv) the number of times the message is categorized by any user in a particular nature; (v) the number of other messages authored by the same user and the number of times said other message are selected and categorized by other users; and (vi) combinations thereof.

5. The system of claim 1, which further comprises a resource management tool that limits the total number of messages authored by a registered user available for display based on criteria selected from the group consisting of: (i) duration criteria for each message authored by said registered user; (ii) the time elapsed since that registered user last had a message selected or categorized by another user; (iii) similarities in the user profiles of said first registered user and the message author-user; (iv) the items of personal data about the message author-user previously awarded to said first registered user; (v) commonality of other third-party registered user messages categorized by said first registered user and each message author; (vi) one or more user filters; and (vii) combinations thereof.

6. The system of claim 5 wherein said user filters are based upon criteria selected from the group consisting of: (i) the categories of personal data in said user profile; (ii) message subject matter; (iii) keywords; (iv) the nature of prior categorization of messages; and (v) total number of messages.

7. The system of claim 1, wherein said personal data includes an image of said second registered user parsable into separately awarded sections.

8. The system of claim 7, wherein said personal data includes contact information of said second registered user awarded after said first registered user has received all image sections of said second registered user.

9. The system of claim 1, wherein said personal data for each registered user includes: (i) information from a user submitted profile; (ii) information concerning the responses provided by other users to said registered user's messages, (iii) the responses provided by said registered user to messages authored by others, and (iv) other messages authored by the same registered user.

10. The system of claim 1 wherein said user interface further includes: a ranking of registered users and messages based upon:
a. user criteria selected from the group consisting of: (i) total number of messages authored; (ii) total number of messages selected and categorized by other users; (iii) total number of users selecting and categorizing messages by other users in a particular manner, (iv) total number of users that have been awarded all or aggregate portions of personal data about other users; and (v) combinations thereof; and
b. by message criteria selected from the group consisting of: (i) total messages that have been selected and categorized; (ii) total messages that have been selected and categorized in a particular manner, and (iii) combinations thereof.

11. The system of claim 1 which further comprises a means for communicating between first and second registered users.

12. The system of claim 1, wherein messages are displayed on said user interface in a moving format on the user interface.

13. The system of claim 12, wherein a registered user can vary the display of messages on said user interface based upon criteria selected from the group consisting of: (i) language; (ii) direction; (iii) delivery speed; (iv) font size; (v) font color; and (vi) combinations thereof.

14. A system of social networking among registered users using gaming principles, said system comprising:
a. a computer network into which parsable profiles of personal data for registered users is stored;
b. a message processing component for receiving multiple messages authored by multiple users, said message processing component associated with said computer network;
c. a user interface for registered users to display and categorize multiple messages from said message processing component to earn portions of the profiles of personal data of message authors based upon the nature of categorized responses to messages.

15. The system of claim 14, wherein said registered user acquires sections of the image of another registered user.

16. The system of claim 15, wherein said registered user earns contact information for the other registered user after earning all image sections for that registered user.

17. A method of exchanging information about registered users in a computer system including a user interface for each registered user whereby a first registered user acquires portions of personal data about a second registered user through gaming principles, said method comprising the steps of:
a. creating a user profile containing portions/items of personal data for each registered user;
b. displaying multiple messages authored by multiple registered users on the user interfaces of multiple registered users;
c. providing the first registered user with means for selecting and categorizing a message authored by the second registered user from among the multiple messages displayed on the user interface of the first registered user; and
d. awarding or removing a portion of personal data about said second registered user to said first registered user based on the first registered user's response to the second registered user's message.

18. The method according to claim 17, further comprising the step of limiting the number of messages said first registered user may select and categorize using a resource management tool selected from the group consisting of: (i) providing credits to said first registered user that are expended or earned based upon said first registered user's categorization of other user messages; (ii) time limitations on when said first registered user can select and categorize other user messages; and (iii) combinations of the above.

19. The method according to claim 17, further comprising the step of limiting the number of messages any registered user can author using a resource management tool selected from the group consisting of: (i) providing credits to each said registered user that are expended as messages are authored and are earned based upon the categorization of each said registered user's messages by other registered users, (ii) time limitations on when each said registered user author messages; and (iii) combinations of the above.

20. The method according to claim 17, further comprising the step of adjusting the duration a message is available for selection and categorization by said first registered user based upon criteria selected from the group consisting of: (i) the time elapsed since the message was first submitted by the author-user of said message; (ii) the time elapsed since the message was last selected or categorized by any registered user; (iii) the number of times the message is selected or categorized by any registered user; (iv) the number of times the message is categorized by any registered user in a particular nature; (v) the number of other messages authored by the same user and the number of times said other messages are selected or categorized by other users; and (vi) combinations thereof.

21. The method according to claim 20, further comprising the step of limiting and selecting the total messages authored by any registered user and available for display to said first registered user based on criteria selected from the group consisting of: (i) said duration criteria associated with each authored message; (ii) the time elapsed since said first registered user selected or categorized another registered user's message; (iii) similarities in the user profiles of said first registered user and other author-user; (iv) the portions of personal data about each message author previously awarded to said first registered user; (v) commonality of other third-party registered user messages categorized by said first registered user and each message author; (vi) one or more user filters; and (vii) combinations thereof.

22. The method according to claim 20 wherein said user filters are based upon criteria selected from the group consisting of: (i) the categories of personal data in said user profile; (ii) message subject matter; (iii) keywords; (iv) the nature of prior categorization of messages; and (v) total number of messages.

23. The method according to claim 17, wherein said personal data awarded to said first registered user includes portions of a personal data category for said second registered user.

24. The method according to claim 23, where said personal data category is an image of said second registered user and said portions are sections of said second registered user's image.

25. The method according to claim 23, further comprising the step of providing contact information of said second registered user to first said registered user when said first registered user is awarded all sections of said second registered user's image.

26. The method according to claim 17, wherein said personal data of the second registered user awarded to said first registered user is comprised of: (i) information from the user profile of said second registered user; (ii) information concerning the responses provided by other users to said second registered user's messages, (iii) the responses provided by said second registered user to messages authored by others, and (iv) other messages authored by said second registered user.

27. The method according to claim 17, further comprising the step of ranking the users and the messages of all individual users, said rankings based upon:
a. user criteria selected from the group consisting of: (i) total number of messages authored; (ii) total number of messages selected and categorized by other users; (iii) total number of users selecting and categorizing messages by other users in a particular manner, (iv) total number of users that have been awarded all or aggregate portions of personal data about other users; and (v) combinations thereof; and
b. by message criteria selected from the group consisting of: (i) total messages that have been selected and categorized; (ii) total messages that have been selected and categorized in a particular manner, and (iii) combinations thereof.

28. The method according to claim 17, wherein said categorization of said authored message is an identified response selected from the group consisting of: (i) one or more binary responses of a particular nature; (ii) a continuum of one or more responses of a particular nature; (iii) a strength rating; and (iv) combinations thereof.

29. The method according to claim 17, further comprising the step of providing a means of communicating between said first and second registered users.

30. The method according to claim 17, wherein authored messages are displayed in a moving format on the user interface and the registered user of that interface can vary the display of messages based upon criteria selected from the group consisting of: (i) language; (ii) direction; (iii) delivery speed; (iv) font size; (v) font color; and (vi) combinations thereof.

31. A method of social networking among registered users over a computer network with a first user earning access to portions of personal data about one or more other registered users based on how said first user categorizes the messages of other registered users posted on said computer network and displayed on individual user interfaces, said method using gaming principles and comprising the steps of:
a. collecting on said computer network parsable profiles for each registered user, each parsable profile including a sectional image of the registered user and contact information for same;
b. displaying a plurality of messages posted by said registered users to select user interfaces from which said first user may categorize other user messages to earn portions of personal data about the authors of categorized user messages;
c. providing the first user with a portion of personal data about the authors of categorized user messages depending upon the nature of such categorization; and
d. providing the first user with contact information for another user when said first user has received sufficient portions of personal data about said other user.
